(19) United States
(12) Patent Application Publication
(10) Pub. No.: US 2003/0003253 A1
(43) Pub. Date: Jan. 2, 2003

(54) Wrapper for a floral grouping formed of a sheet of material having a contoured configuration

(76) Inventor: Donald E. Weder, Highland, IL (US)

Correspondence Address: DUNLAP, CODDING & ROGERS P.C., PO BOX 16370, OKLAHOMA CITY, OK, 73114, US

(21) Appl. No.: 10/218,341

(22) Filed: Aug. 12, 2002

Related U.S. Application Data
(62) Division of application No. 09/760,689, filed on Jan. 16, 2001.

(51) Int. Cl. B32B 1/08

(52) U.S. Cl. 428/36.9; 428/80; 428/81

(57) ABSTRACT

A wrapper for a floral grouping includes a sheet of material having a contoured configuration such that the wrapper formed therefrom has a contoured configuration which closely approximates the configuration of the floral grouping, as well as methods for making same. The sheet of material may be constructed of waxed tissue, non-waxed tissue or a tissue substitute, such as a tissue having a texture or appearance simulating the texture or appearance of waxed tissue.

### CROSS-REFERENCE TO RELATED APPLICATIONS

This application is a divisional of U.S. Ser. No. 09/760,689, filed Jan. 16, 2001.

### STATEMENT REGARDING FEDERALLY SPONSORED RESEARCH OF DEVELOPMENT

Not Applicable.

### BACKGROUND

The present invention relates to methods of wrapping a floral grouping with a wrapper and, in particular, but not limited to, methods of wrapping a floral grouping with a wrapper formed of a sheet of material having a configuration contoured to approximate the configuration of the floral grouping.

In the past, waxed tissue for wrapping floral bouquets has been sold wherein the waxed tissue was square or rectangular shaped, and upon wrapping such waxed tissue about the floral grouping, such as a bouquet of real or artificial cut flowers, portions of the material were overlapped so that the waxed tissue could be secured in a position about the floral grouping. Such waxed tissue has also been sold on rolls wherein rectangular or square sheets of material can be removed from the rolls for wrapping about floral groupings. However, such methods of wrapping floral groupings with square or rectangular sheets of material results in excess material being incorporated in the wrapper due to the overlapping portions of material in the wrapper, and therefore a need exists in the art to provide sheets of material for wrapping floral groupings which are more cost efficient and less bulky, thereby providing a more attractive and desirable wrapper for a floral grouping.

### BRIEF DESCRIPTION OF THE DRAWINGS

FIG. 1 is a perspective view of a sheet of material constructed in accordance with the present invention, the sheet of material having one corner turned upwardly to show a lower surface thereof.

FIG. 2 is a perspective view of another embodiment of a sheet of material constructed in accordance with the present invention, the sheet of material having one corner turned upwardly to show a lower surface thereof.

FIG. 3 is a perspective view of yet another embodiment of a sheet of material constructed in accordance with the present invention.

FIG. 4 is a perspective view of the sheet of material of FIG. 3 having a floral grouping disposed thereon.

FIG. 5 is a perspective view of the sheet of material and floral grouping of FIG. 4, wherein the sheet of material is being wrapped about the floral grouping.

FIG. 6 is a perspective view of a wrapper for the floral grouping formed from the sheet of material of FIG. 4.

### DETAILED DESCRIPTION OF THE INVENTION

The present invention relates to sheets of material which may be employed to wrap floral groupings which avoid the defects and disadvantages of the prior art. The sheets of material of the present invention are provided with a contoured configuration which approximates the configuration of the floral grouping to be wrapped therein, thereby reducing the amount of material required to produce the wrapper and providing a more cost efficient and less bulky wrapper for floral groupings.

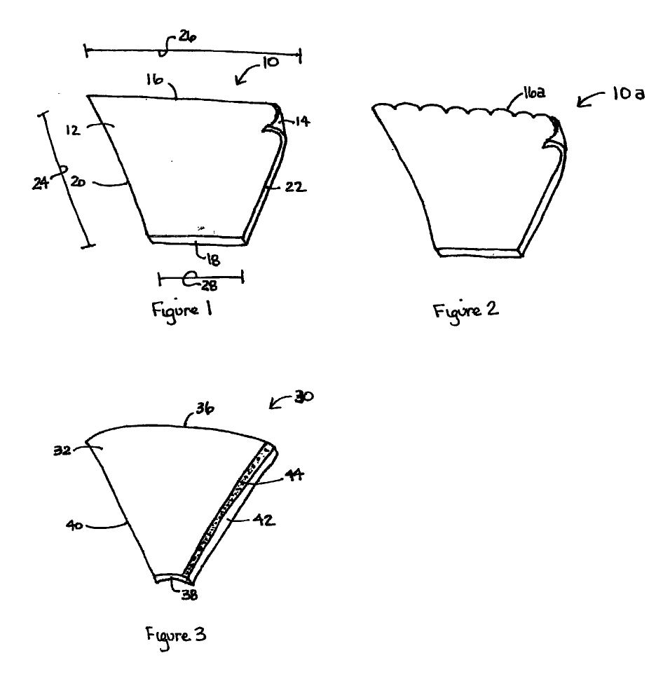

Turning now to the Drawings, shown in FIG. 1 is a sheet of material 10 constructed in accordance with the present invention. The sheet of material 10 has an upper surface 12, a lower surface 14, a first side 16, a second side 18, a third side 20 and a fourth side 22. The sheet of material 10 is provided with a substantially trapezoidal configuration, that is, the first and second sides 16 and 18 of the sheet of material 10 are substantially parallel whereas the third and fourth sides 20 and 22 of the sheet of material 10 are not parallel.

The sheet of material 10 may be constructed of any flexible material which can function as described herein in accordance with the present invention. Preferably, the sheet of material 10 is constructed of waxed tissue. However, the sheet of material 10 may be constructed of a tissue substitute, such as a polymeric film provided with a texture and/or appearance simulating the texture and/or appearance of waxed tissue. The sheet of material 10 may also be constructed of a non-waxed tissue.

Any thickness or stiffness of the sheet of material 10 may be utilized in accordance with the present invention as long as the sheet of material 10 is flexible and may be wrapped about at least a portion of a floral grouping, as described herein. Generally, the sheet of material 10 will have a thickness in a range of from about 0.1 mil to about 30 mil, and desirably in a range of from about 0.2 mil to about 10 mil.

The term “polymer film” when used herein refers to a synthetic polymer such as a polypropylene or polyethylene or a naturally occurring polymer such as cellophane. A polymer film is relatively strong and not as subject to tearing (substantially non-tearable), as might be the case with tissue.

The sheet of material 10 may vary in color. Further, the sheet of material 10 may be provided with decorative patterns or designs which are printed, etched, and/or embossed on at least a portion of one of the upper and lower surfaces 12 and 14 thereof. In addition, the sheet of material 10 may have various colorings, coatings, flocking and/or metallic finishes applied separately or simultaneously, or the sheet of material 10 may be characterized totally or partially by pearlescent, opaque, translucent, transparent, tinted, iridescent or the like qualities. Each of the above-named characteristics may occur alone or in combination. Moreover, each of the upper and lower surfaces 12 and 14 of the sheet of material 10 may vary in the combination of such characteristics. Further, one of the above-named characteristics may occur on only a portion of one of the upper and lower surfaces 12 and 14 of the sheet of material 10. For example, a lower portion of the sheet of material 10 may be provided with a printed, pattern thereon while an upper portion of the sheet of material 10 may be transparent such that a bloom portion of a floral grouping disposed in a wrapper formed from the sheet of material 10 may be visible through the wrapper.

The sheet of material 10 has a length 24 extending generally between the first side 16 and the second side 18, respectively, sufficiently sized whereby the sheet of material 10 can be wrapped about and encompass a substantial portion of a floral grouping. The first side 16 of the sheet of material 10 has a width 26 extending generally between the third side 20 and the fourth side 22, while the second side 18 of the sheet of material 10 has a width 28 extending generally between the third side 20 and the fourth side 22 of the sheet of material 10. The width 26 of the first side 16 of the sheet of material 10 is substantially larger than the width 28 of the second side 18 of the sheet of material 10, and therefore the sheet of material 10 is tapered downwardly from the first side 16 to the second side 18 thereof to provide the sheet of material 10 with a substantially trapezoidal configuration. The width 26 of the first side 16 of the sheet of material 10 is sufficiently sized whereby an upper portion of the sheet of material 10 extends over a substantial portion of a bloom portion of a floral grouping when the sheet of material 10 has been wrapped about the floral grouping in accordance with the present invention, as described in detail herein below, whereas the width 28 of the second side 18 of the sheet of material 10 is sufficiently sized whereby a lower portion of the sheet of material 10 extends over a substantial portion of a stem portion of a floral grouping when the sheet of material 10 has been wrapped about the floral grouping in accordance with the present invention, as described in detail herein below.

Shown in FIG. 2 is a sheet of material 10a which is similar to the sheet of material 10 shown in FIG. 1, except that a first side 16a of the sheet of material 10a is provided with a non-linear configuration, i.e., a scalloped configuration, whereas the first side 16 of the sheet of material 10 of FIG. 1 is provided with a linear configuration substantially as shown. While the first sides 16 and 16a of the sheets of material 10 and 10a are illustrated as having linear and non-linear configurations, respectively, it will be understood that the ends of the sheets of material of the present invention may be provided with other configurations, such as curved configurations, ornamental or non-ornamental configurations, geometrical, non-geometrical, asymmetrical or fanciful configurations. Further, it will be understood that any of the sides of the sheets of material 10 or 10a may be provided with such decorative configurations, either alone or in combination.

Shown in FIGS. 3-5 is another embodiment of a sheet of material designated therein by the reference numeral 30. The sheet of material 30 is similar to the sheet of material 10 described herein before with reference to FIG. 1, except as described herein below. The sheet of material 30 is provided with an upper surface 32, a lower surface 34 (FIG. 5), a first side 36, a second side 38, a third side 40 and a fourth side 42. The sheet of material 30 is provided with a substantially triangular configuration. The first and second sides 36 and 38 thereof are provided with a substantially curved configuration, wherein the configuration of the first side 36 is substantially convex and the configuration of the second side 38 is substantially concave. However, it is to be understood that the configuration of the first side 36 may be substantially concave and the configuration of the second side 38 may be substantially convex, or the configurations of the first and second sides 36 and 38 may both be substantially concave or substantially convex.

The sheet of material 30 is further provided with a bonding material 44 disposed on at least a portion of one of the upper surface 32 and the lower surface 34 thereof. For example, the bonding material 44 is illustrated in FIGS. 3-5 as being in the form of a strip of bonding material 44 which is disposed on a portion of the upper surface 32 of the sheet of material 30 substantially adjacent the fourth side 42 thereof and extending between the first and second sides 36 and 38 of the sheet of material 30. However, the bonding material 44 may be disposed as spots or in any other geometric, non-geometric, asymmetric, or fanciful form, and in any pattern including covering either the entire upper surface 32 and/or the entire lower surface 34 of the sheet of material 30. The bonding material 44 may be covered by a cover or release strip which can be removed prior to the use of the sheet of material 30. The bonding material 44 can be applied by methods known to those of ordinary skill in their art. One method for disposing a bonding material, in this case an adhesive, is described in U.S. Pat. No. 5,111,637, which is hereby expressly incorporated herein by reference.

The term “bonding material” when used herein can include an adhesive, frequently a pressure sensitive adhesive, a cohesive or any adhesive/cohesive combination having adhesive qualities (i.e., qualities of adhesion or adhesion/cohesion, respectively) sufficient to cause the attachment of a portion of the sheet of material 10 to itself or to a portion of a floral grouping. It will be appreciated that both adhesives and cohesives are known in the art, and both are commercially available. When the bonding material 44 is a cohesive, a similar cohesive material must be placed on the opposite surface of the sheet of material 30 for bondingly contacting and bondingly engaging with the cohesive material. Other types of bonding materials are known in the art, and it will be understood that different types of bonding materials not described herein which are known to a person of ordinary skill in the art may be employed in the present invention.

The term “bonding material” when used herein also includes any type of material or thing which can be used to effect the bonding or connecting of the two adjacent portions of the material or sheet of material to effect the connection or bonding described herein. The term “bonding material” may also include ties, labels, bands, ribbons, strings, tapes (including single or double-sided adhesive tapes), staples or combinations thereof.

While only the sheet of material 30 is described and illustrated herein as having a bonding material disposed thereon, it will be understood that any of the sheets of material described herein may be provided with a bonding material disposed thereon in a similar manner, and that such sheets of material having a bonding material disposed thereon may be employed to wrap a floral grouping as described in detail herein below. It will also be understood that the sheet of material 30 may be free of a bonding material.

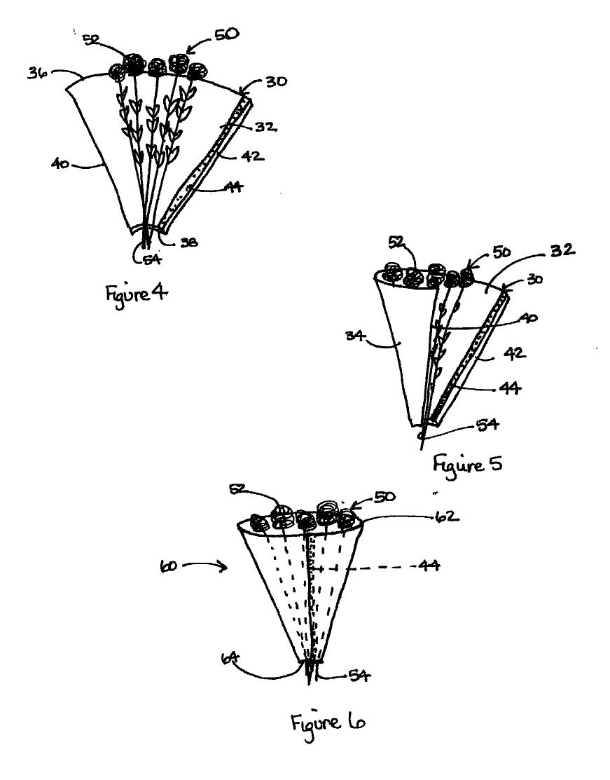

Shown in FIGS. 4-6 is a method of use of one of the sheets of material of the present invention to wrap a floral grouping. While the method will be described in detail with reference to the sheet of material 30, it will be understood that the sheets of material 10 and 10a or any other sheets of material described herein may be utilized to wrap a floral grouping in a substantially similar manner, and therefore the invention is not limited to the embodiment shown in FIGS. 4-6.

As illustrated in FIG. 4, a floral grouping 50 is disposed on the upper surface 32 of the sheet of material 30. The floral grouping 50 comprises a bloom portion 52 and a stem portion 54. The floral grouping 50 is disposed on the sheet of material 30 such that the bloom portion 52 of the floral grouping 50, which is substantially wider than the stem portion 54 of the floral grouping, is substantially adjacent the portion of the sheet of material 30 having the greatest width, that is, a portion of the bloom portion 52 is disposed substantially adjacent the first side 36 of the sheet of material 30, whereas a portion of the stem portion 54 is disposed substantially adjacent the second side 38 of the sheet of material 30.

The sheet of material 30 is wrapped about the floral grouping 50 by any method known in the art. For example, as shown in FIGS. 4-6, the third side 40 of the sheet of material 30 may be placed over the floral grouping 50 as shown in FIG. 5. Then the sheet of material 30 and the floral grouping 50 may be rolled in a direction toward the fourth side 42 until the upper surface 32 of the sheet of material 30 adjacent the fourth side 42 engages the lower surface 34 of the sheet of material 30 such that the bonding material 44 bondingly connects the upper and lower surfaces 32 and 34 of the sheet of material 30, thereby forming a decorative wrapper 60 for the floral grouping 50, substantially as shown in FIG. 6. The decorative wrapper 60 substantially encompasses and surrounds a substantial portion of the floral grouping 50.

In an optional method of wrapping the sheet of material 30 about the floral grouping 50, following the placement of the third side 40 of the sheet of material 30 over the floral grouping 50 as shown in FIG. 5, the fourth side 42 of the sheet of material 30 may also be brought up and placed over the floral grouping 50 as well as the third side 40 of the sheet of material 30 until the upper surface 32 of the sheet of material 30 adjacent the fourth side 42 engages the lower surface 34 of the sheet of material 30 such that the bonding material 44 bondingly connects the upper and lower surfaces 32 and 34 of the sheet of material 30, thereby forming the decorative wrapper 60 which substantially surrounds and encompasses the floral grouping 50 as shown in FIG. 6.

The decorative wrapper 60 has an open upper end 62 and a lower end 64. The bloom portion 52 of the floral grouping 50 is disposed substantially adjacent the open upper end 62 of the decorative wrapper 60 and the stem portion 54 of the floral grouping 50 is disposed substantially adjacent the lower end 64 of the decorative wrapper 60. The lower end 64 of the decorative wrapper 60 may be closed such that the stem portion 54 of the floral grouping 50 is maintained in the decorative wrapper 60 and is not exposed beyond the lower end 64 of the decorative wrapper 60.

The decorative wrapper 60 is provided with a substantially conical configuration, i.e., the decorative wrapper 60 is tapered downwardly from the open upper end 62 thereof to a substantially smaller diameter at the lower end 64 thereof. In this fashion, the decorative wrapper 60 is contoured to approximate the configuration of the floral grouping 50, that is, the decorative wrapper 60 is provided with a larger diameter at the open upper end 62 thereof so that such diameter closely approximates the size of the bloom portion 52 of the floral grouping 50 disposed therein, while the decorative wrapper 60 is provided with a substantially smaller diameter at the lower end 54 thereof so that such diameter closely approximates the size of the stem portion 54 of the floral grouping 50 disposed therein. By forming the decorative wrapper 60 in this manner, a smaller amount of material is required to form the sheet of material 30 than the square or rectangular sheets of the prior art, thereby providing a more cost efficient method of forming a decorative wrapper 60 as well as providing a decorative wrapper 60 containing less bulk of material by minimizing the amount of overlapping material.

As stated herein before, a decorative wrapper substantially similar to and formed in a similar manner as the decorative wrapper 60 described herein before with reference to FIGS. 4-6 may be formed from either of the sheets of material 10 or 10a or any other sheets of material described herein. While the configurations may vary somewhat depending on the specific configuration and contour of the sheet of material, such decorative wrappers will also be provided with a contoured configuration which approximates the configuration of the floral grouping 50, and such decorative wrappers will also be provided with an open upper end disposed substantially adjacent the bloom portion 52 of the floral grouping 50 and a lower end disposed substantially adjacent the stem portion 54 of the floral grouping 50. For example, a decorative wrapper formed from one of the sheets of material 10 or 10a will have a substantially frusto-conical configuration. which approximates the configuration of the floral grouping 50. When the decorative wrapper is formed from the sheet of material 10, the upper end of such decorative wrapper will be substantially linear, whereas the upper end of a decorative wrapper formed from the sheet of material 10a will be provided with a scalloped configuration which provides a decorative appearance upon disposing the upper end of the decorative wrapper substantially adjacent to the bloom portion 52 of the floral grouping. In a further alternative, a sheet of material may be utilized which is substantially similar to the sheets of material 10 and 10a, except that the sheet of material is provided with a curved upper end similar to the curved configuration of the first side 36 of the sheet of material 30 as shown in FIG. 3. When a decorative wrapper is formed from such sheet of material, an upper end thereof will be substantially linear in three-dimensions. Further, a sheet of material may be employed which is provided with other ornamental shapings on an upper end thereof such that a decorative wrapper formed therefrom is provided with an upper end having a decorative ornamental appearance.

Changes may be made in the construction and the operation of the various components, elements and assemblies described herein or in the steps or the sequence of steps of the methods described herein without departing from the spirit and scope of the invention as defined in the following claims.

What is claimed:

1. A decorative wrapper for a floral grouping, the decorative wrapper comprising a sheet of material having an upper surface, a lower surface, a first side, a second side, a third side and a fourth side, the sheet of material having a substantially trapezoidal configuration such that when the sheet of material is formed into the decorative wrapper about a floral grouping, the decorative wrapper is provided with a substantially frusto-conical configuration with closely approximates the configuration of the floral grouping disposed therein.

2. The decorative wrapper of claim 1 wherein the sheet of material is constructed of a material selected from the group consisting of waxed tissue, a non-waxed tissue, and a polymeric film having a texture or appearance simulating the texture or appearance of waxed tissue.

3. The decorative wrapper of claim 2 wherein the sheet of material is further provided with a bonding material disposed on at least a portion of the upper surface thereof such that the sheet of material may be secured about the floral grouping via the bonding material, thereby holding the sheet of material in the configuration of the decorative wrapper.

4. The decorative wrapper of claim 2 wherein at least one of the first, second, third and fourth sides of the sheet of material are provided with linear, non-linear or scalloped configurations.

5. A decorative wrapper for a floral grouping, the decorative wrapper comprising a sheet of material having an upper surface, a lower surface, a first side, a second side, a third side and a fourth side, the sheet of material having a substantially triangular configuration such that when the sheet of material is formed into the decorative wrapper about a floral grouping, the decorative wrapper is provided with a substantially conical configuration with closely approximates the configuration of the floral grouping disposed therein.

6. The decorative wrapper of claim 5 wherein the sheet of material is constructed of a material selected from the group consisting of waxed tissue, a non-waxed tissue, and a polymeric film having a texture or appearance simulating the texture or appearance of waxed tissue.

7. The decorative wrapper of claim 5 wherein the sheet of material is further provided with a bonding material disposed on at least a portion of the upper surface thereof such that the sheet of material may be secured about the floral grouping via the bonding material, thereby holding the sheet of material in the configuration of the decorative wrapper.

8. The decorative wrapper of claim 5 wherein at least one of the first, second, third and fourth sides of the sheet of material are provided with linear, non-linear or scalloped configurations.
